(19) United States
(12) Patent Application Publication
(10) Pub. No.: US 2025/0013966 A1
(43) Pub. Date: Jan. 9, 2025

(54) SYSTEMS AND METHODS FOR INFORMATION MONITORING FOR CONTEXTUALLY-RELEVANT DATA

(71) Applicant: MicroStrategy Incorporated, Tysons Corner, VA (US)

(72) Inventors: Jeffrey C. COURCELLE, Tysons Corner, VA (US); Timothy LANG, Tysons Corner, VA (US); Qingru SHEN, Tysons Corner, VA (US); Lingyu ZHU, Tysons Corner, VA (US); Yingchun MEI, Hangzhou (CN); Xiaodi ZHONG, Hangzhou (CN); Nida IMTIAZ, Vienna, VA (US); Ananya OJHA, Dunn Loring, VA (US)

(73) Assignee: MicroStrategy Incorporated, Tysons Corner, VA (US)

(21) Appl. No.: 18/892,755

(22) Filed: Sep. 23, 2024

Related U.S. Application Data
(62) Division of application No. 18/162,510, filed on Jan. 31, 2023.
(60) Provisional application No. 63/267,401, filed on Feb. 1, 2022.

(51) Int. Cl. G06Q 10/0639; G06Q 30/0202

(52) U.S. Cl. CPC G06Q 10/06393; G06Q 30/0202

(57) ABSTRACT

A method of managing information monitoring for contextually-relevant data, by determining a plurality of subscription configuration settings of one or more data of a plurality of data sources with respect to a plurality of users, each subscription configuration setting being based on an interaction with an application interface by a respective user among the plurality of users; determining a plurality of groups of users among the plurality of users, each group of users being determined based on one or more attributes of each user of the group or respective subscription configuration settings of each user of the group; determining, for a targeted user among the plurality of users an affiliated group among the plurality of groups of users; and determining a recommended subscription configuration setting for the targeted user of one or more data of the plurality of data source based on the affiliated group.

### CROSS-REFERENCE TO RELATED APPLICATION

This patent application is a divisional of and claims the benefit of priority to U.S. application Ser. No. 18/162,510, filed on Jan. 31, 2023, which claims benefit to U.S. Provisional Patent Application No. 63/267,401, filed on Feb. 1, 2022, the entire contents of each of which are incorporated herein by reference.

### TECHNICAL FIELD

The present disclosure relates to systems and methods for information monitoring for contextually-relevant data.

### INTRODUCTION

Today's electronic networks commonly contain more information than is possible for a user to efficiently search and assimilate. A user may utilize a search engine to look up information, but this may lead to frustration, as the user may not know the words to perform an optimal search, or may not know how to acquire the most relevant information. Furthermore, requiring the user to determine a query and type the query into a search engine may also take up unnecessary time, which may lead to further negative experiences.

The introduction provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to another aspect, a method of managing information monitoring for contextually-relevant data includes: determining a plurality of subscription configuration settings of one or more data of a plurality of data sources with respect to a plurality of users, each subscription configuration setting being based on an interaction with an application interface by a respective user among the plurality of users; determining a plurality of groups of users among the plurality of users, each group of users being determined based on one or more attributes of each user of the group or respective subscription configuration settings of each user of the group; determining, for a targeted user among the plurality of users an affiliated group among the plurality of groups of users; and determining a recommended subscription configuration setting for the targeted user of one or more data of the plurality of data source based on the affiliated group.

According to another aspect, a system for managing information monitoring for contextually-relevant data comprising: one or more processor; and one or more machine-readable media store software including instructions that, when executed by the one or more processors, cause the system to perform operations comprising: determining a plurality of subscription configuration settings of one or more data of a plurality of data sources with respect to a plurality of users, each subscription configuration setting being based on an interaction with an application interface by a respective user among the plurality of users; determining a plurality of groups of users among the plurality of users, each group of users being determined based on one or more attributes of each user of the group or respective subscription configuration settings of each user of the group; determining, for a targeted user among the plurality of users an affiliated group among the plurality of groups of users; and determining a recommended subscription configuration setting for the targeted user of one or more data of the plurality of data source based on the affiliated group.

According to another aspect, one or more non-transitory computer-readable media storing instructions that, when executed by one or more processors, cause a performance of operations for managing information monitoring for contextually-relevant data, the operations comprising: determining a plurality of subscription configuration settings of one or more data of a plurality of data sources with respect to a plurality of users, each subscription configuration setting being based on an interaction with an application interface by a respective user among the plurality of users; determining a plurality of groups of users among the plurality of users, each group of users being determined based on one or more attributes of each user of the group or respective subscription configuration settings of each user of the group; determining, for a targeted user among the plurality of users an affiliated group among the plurality of groups of users; and determining a recommended subscription configuration setting for the targeted user of one or more data of the plurality of data source based on the affiliated group.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment in which systems methods and other aspects of the present disclosure may be implemented.

FIG. 2 depicts an example information monitor editor for configuring monitored contextually-relevant information, according to embodiments of the present disclosure.

FIG. 3 depicts another example information monitor editor for configuring monitored contextually-relevant information, according to embodiments of the present disclosure.

FIG. 3A depicts an example data threshold selector, according to embodiments of the present disclosure.

FIG. 4 depicts another example information monitor editor for configuring monitored contextually-relevant information, according to embodiments of the present disclosure.

FIG. 5 depicts another example information monitor editor for configuring monitored contextually-relevant information, according to embodiments of the present disclosure.

FIG. 6 depicts example design functionalities for displaying monitored contextually-relevant information, according to embodiments of the present disclosure.

FIG. 7 depicts additional example design functionalities for displaying monitored contextually-relevant information, according to embodiments of the present disclosure.

FIG. 8 depicts example subscription functionalities for displaying monitored contextually-relevant information, according to embodiments of the present disclosure.

FIG. 9 depicts additional example subscription functionalities for displaying monitored contextually-relevant information, according to embodiments of the present disclosure.

FIG. 10 depicts an example user interface of the subscription for displaying monitored contextually-relevant information, according to embodiments of the present disclosure.

FIG. 11 depicts example sharing functionalities for displaying monitored contextually-relevant information, according to embodiments of the present disclosure.

FIG. 12 depicts example managing functionality for displaying monitored contextually-relevant information, according to embodiments of the present disclosure.

FIG. 13 depicts an example display of monitored contextually-relevant information, according to embodiments of the present disclosure.

FIG. 14 is a flow chart of an example method of monitoring contextually-relevant information, according to embodiments of the present disclosure.

FIG. 15 depicts live model page, according to embodiments of the present disclosure.

FIG. 16 depicts an insight approval page, according to embodiments of the present disclosure.

FIG. 17 depicts an augmented visualization generation page, according to embodiments of the present disclosure.

FIG. 18 depicts a user insight summary communication, according to embodiments of the present disclosure.

FIG. 19 is a flow chart of an example method of recommending insights to users, according to embodiments of the present disclosure.

FIG. 20 is a flow chart of an example method of providing user experiences to users, according to embodiments of the present disclosure.

FIG. 21 is a data flow for training a machine learning model, according to embodiments of the present disclosure.

FIG. 22 depicts an exemplary computer device or system, in which embodiments of the present disclosure, or portions thereof, may be implemented.

Like reference numbers and designations in the various drawings indicate like elements.

### DETAILED DESCRIPTION

The subject matter of the present description will now be described more fully hereinafter with reference to the accompanying drawings, which form a part thereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter can be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially,” “approximately,” and “generally,” are used to indicate a possible variation of ±10% of a stated or understood value.

In the following description, embodiments will be described with reference to the accompany drawings. Various embodiments of the present disclosure relate generally to methods and systems for information monitoring for contextually-relevant data.

As described above, users searching or monitoring contextually-relevant information may be overwhelmed with the amount of information available and have difficulties monitoring the information. Contextually-relevant information may be made up of a plurality of data points. In many conventional systems, users may have to keep track of individual data points manually by looking up and/or searching for individual sources of the data points. Users may also have to create reminders or alerts to monitor the individual data points. For example, the users may set up a to-do list or a reminder email to search and monitor each individual data point at a frequency that is appropriate for the users.

A further challenge arises since the contextually-relevant information may be assembled from a plurality of data sources, including third party data sources, which may make the process slow and degrade the user experience.

The techniques discussed herein address these and other challenges by allowing data to be presented inline or otherwise associated with applications, and provide an efficient way for users to access the information, such as analytics data, in a user interface. By allowing a user to call up monitored contextually-relevant data within an existing user interface, the user no longer needs to switch applications or look through multiple data sources, thereby losing the context of the applications involved in the user's current task. Additionally, techniques disclosed herein provide analysis of contextually-relevant data such that the contextually-relevant data may be supplemented with one or more visualizations, trends, predictions, summaries, and/or the like or a combination thereof.

Traditionally, if a user desires to look up and/or monitor information from an analytics platform or other database-backed platform, the user generally needs to switch applications or windows, log in, submit a query for the information desired, and wait for results to be returned. The delays, multiple steps required, and overall inconvenience often discourage users from looking up needed information.

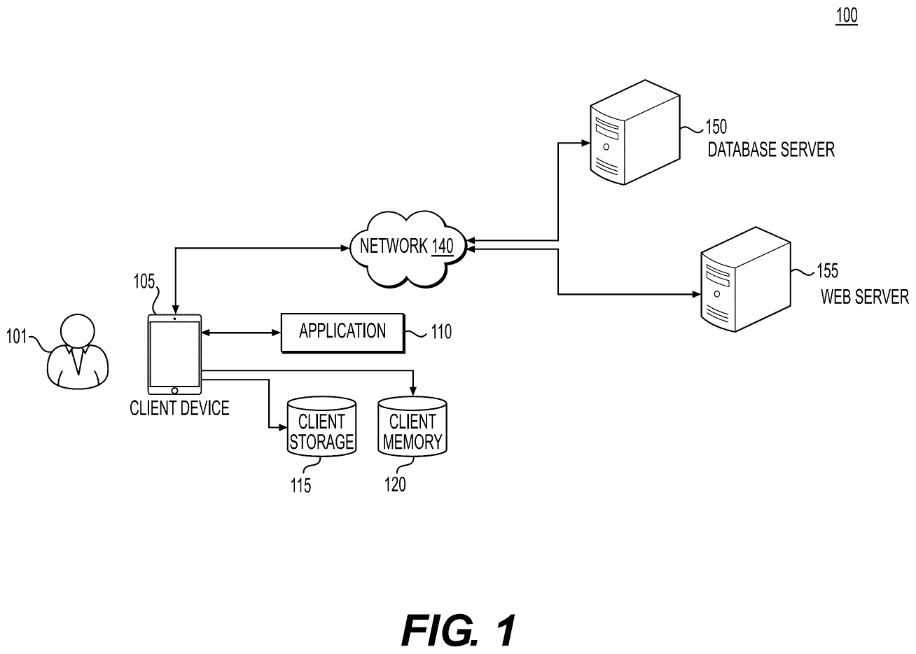

By contrast, the techniques in the present application do not require the user to switch applications or interfaces, and contextually-relevant information is automatically provided in an interface, or overlapping/adjacent thereto, where the user needs the information. Such contextually-relevant information may be provided at user determined intervals, or may be provided when attributes of the contextually-relevant information meet a trigger threshold (e.g., a change in values, a rate of change, a trend, etc.) This automatic provision of contextually-relevant information provides information to just the right user, at the right time, at the user interface where the information is needed. Delays are minimal because the client device can receive contents of the information before the user indicates that the information should be displayed. Also, the user can call up the information with a single action on the existing interface, such as a mouse-over, hover, click, gaze, gesture, or tap on a term in the user interface. While the term “cursor” may be used herein, this term may also indicate points of user focus on the screen even though no visible cursor is present. For example, a user placing a finger on a touchscreen may indicate a point of user focus that may be called a cursor, even though a visible cursor might not be present. FIG. 1 depicts an exemplary environment 100 in which systems, methods, and other aspects of the present disclosure may be implemented. The environment 100 may include one or more client devices 105, one or more database servers 150, and/or one or more web servers 155. The client device 105, database server 150, and web server 155 may communicate with each other across one or more networks 140. The network 140 may be any suitable network or combination of networks and may support any appropriate protocol suitable for data communication between various components in the system environment 100. The network 140 may include a public network (e.g., the Internet), a private network (e.g., a network within an organization), or a combination of public and/or private networks. The database server 150 may be implemented using multiple computers that cooperate to perform the functions discussed below, and which may be located remotely from each other.

The client device 105 may include an application 110 that enables the client device 105 to dynamically generate and display contextually-relevant information inline with, or adjacent to, the application 110 on an electronic display of the client device 105. As discussed below, the application 110 may allow the client device 105 to obtain and provide information from the database server 150 and the web server 155, even though the application 110, which may access a web page or app, may be controlled by third parties.

The client device 105 may be associated with a user 101, who may be a member of an organization, e.g., an employee of a company. The database server 150 may store database records stored by or for the user or the organization. The records might not be publicly available and may be subject to data access restrictions, such as requirements that users be issued credentials, for example from the organization, that grant authorization to access the records. Different users may be granted different levels of authorization, and the database server 150 may enforce access restrictions so that each user is only allowed to access the subsets of information the user is authorized to access. Techniques used herein may also accumulate data from publicly available databases for displaying contextually-relevant information.

In the environment 100, instead of incorporating additional content into the source of a document or application, information may be instead added, just in time, through the application 110, for example, a browser extension for a web browser, a subroutine of application 110, etc. This provides the flexibility for the system to selectively provide dynamically changing content from the database server 150 for any interface shown on the application 110, e.g., any web application or web page displayed by a web browser, any user interface displayed on the electronic display of the client device 105, etc.

In the example of FIG. 1, the client device 105 may communicate with the web server 155 to obtain and display a page of a web site or other user interface of the application 110. Web server 155 may make available an Application Programming Interface (API) through which information may be provided. Alternatively, application 110 may comprise a native desktop application, and may require no communication or minimal communication with web server 155. The client device 105 may generate an electronic display for the application 110, or may generate displays in the electronic display for more than one application. Concurrently, the application 110 may run on the client device 105 and may receive the text content of the rendered page. The electronic display may comprise a desktop displaying one or more applications, including application 110.

The application 110 may require the user 101 to authenticate and thus prove authorization to receive content from the database server 150. The authentication of the user 101 may also indicate to the application 110 and/or database server 150 the role of the user in the organization (e.g., software engineer, marketing technician, financial analyst, and so on) and the specific level of access authorization that has been, or will be, granted to the user 101 by the organization.

With the user logged in, the application 110 may access a set of data points, e.g., contextually-relevant data, that are relevant to the user 101 and/or the organization. The set of data points may be stored at the client device 105 or may be stored in the database server 150. The data points may also be stored in client storage 115, which may comprise non-volatile storage, and/or client memory 120, which may comprise volatile storage, where the client memory 120 may provide faster data access speeds than the client storage 115. In some implementations, the set of data points may be requested and received from the database server 150 each time the user 101 authenticates. The set of data points may represent analytics data stored in database server 150, for example, analytics data representing product sales amounts or inventory levels.

According to an implementation, the set of data points may be stored using a semantic architecture. The semantic architecture may allow access to trusted enterprise data and to quickly build reports and visualizations, blending data from multiple systems. The systems and components disclosed herein may use the semantic architecture to produce actionable intelligence from structured, unstructured, and semi-structured data warehouses, enterprise directories, and other enterprise data assets. The semantic architecture may allow logical business abstraction of enterprise data assets combined with an object-oriented architecture to facilitate object reusability, trusted governance, and user collaboration. The semantic architecture may further facilitate provision of governed, self-service analytics. The semantic architecture may be implemented by using a semantic layer that functions as an index of and/or on top of an organization's enterprise data assets.

As applied herein, an author may generate the framework for application 110 such that application 110 can be customized for one or more clients (e.g., by a user creating a canvas). The author may determine the functionality and/or objects that can be used for a given client, such that application 110 can be generated based on the functionality and/or objects. An example functionality may be one or more insights. An insight may be generated based on a set of analytics capabilities that allow a client to analyze volumes of structured and unstructured data in its native format. An insight may be or may be based on a relationship (e.g., between multiple dimensions of data, such as data in a semantic architecture), a correspondence, a correlation, a trend, or the like or a combination thereof, and may be used to generate a dossier. As further discussed herein, insights based on selected data for monitoring and/or automatically identified datasets may be approved by authors for display via application 110.

As applied herein, one or more visualizations may be built and provided to a client (e.g., via client device 105). The one or more visualizations may be provided via application 110. A client may elect a subset of the one or more visualizations based on the insights approved by an author for a given application 110 or applicable dossier.

Techniques disclosed herein may allow users to identify key data in their respective applications (e.g., application 110), and elect to monitor the key data. A summary of changes and/or lack of changes may be provided to users during subsequent access to dossiers, after selection of the key data. Natural Language Generation (NLG) may be used to provide explanations of factors responsible for driving the change or lack of change in the data. The state of the data (e.g., changes, lack of changes, types of changes, etc.) may be delivered via a subscription. The subscription may include information about data and information about subscribed data and may be delivered via a central platform (e.g., a live model) and/or may be provided via an application (e.g., a messaging service, an email service, etc.).

One or more thresholds may be set such that a data property that changes by a threshold value may be flagged (e.g., included in a subscription delivery, via a live model page, via a message, via an email, via an application etc.). According, implementing this guided delivery of data updates across different data sets, via a central or applicable application, may augment user experience, reduce an amount of processing time required to access multiple data sets individually, and reduce resource use in presenting individual data sets or corresponding platforms to a user. Key data may be presented to a user in a centralized manner, in a subscription manner, and/or at a platform where the data is most useful (e.g., instead of the user accessing multiple platforms to access the same data).

As also further disclosed herein, an author (e.g., a dossier author) may be provided engine generated insights for one or more client application. The insights may be generated based on a combination of Artificial Intelligence (AI) analysis of the dimensions and/or trends as well as machine learning models. The machine learning models may be trained using supervised data, unsupervised data, and/or semi-supervised data to generate machine learning outputs that identify patterns in usage and/or data and generate insights based on the same. For example, for a given dataset or type of dataset (e.g., a type of dataset may be determined based on its attributes, metrics, dimensions, etc.), a machine learning or other output may indicate that approximately 85% of time when the given dataset or type of dataset is selected, users build three specific visualizations. Accordingly, the underlying logic behind those three specific visualizations may be generated into an insight and provided to the author for approval. The author may approve or reject generated insights, thereby governing insights offered to one or more clients. By governing the insights provided to clients, the insights may be curated. Approved insights may be deployed to the application users who may provide feedback (e.g., accept insight, reject insight, modify insight, etc.). The feedback may be provided to the author or may be input to a machine learning model. The author or machine learning output may be used to further tailor the insights based on the feedback.

According to another implementation, techniques and systems disclosed herein may identify common dimensions in datasets. The common dimensions may be used for analysis for any given dataset or combination of datasets. Datasets with common dimensions may be linked such that visualizations may be generated based on linked datasets for data analysis. Linked visualizations may be automatically generated when the linked datasets or other datasets with similar dimensions are used (e.g., selected) by a user. Auto-generated visualizations may be provided when authors connect to one of a linked dataset. Further, additional linked datasets may be imported automatically based on the selection of a first linked dataset. These techniques may improve processing time by reducing the number of datasets to be selected, reduce the time required create common analysis patterns, and also reduce the complexity in generating linked visualizations.

According to an implementation, upon detection of a common dimension and/or visualization pattern (e.g., by a machine learning model), a certified visualization may be created. The certified visualization may be formatted, themed, and/or grouped with other objects (e.g., as output by the machine learning model or determined by an author). Such objects may include, for example, attribute or metric selectors, in-canvas filters, panel stacks and more. Grouped objects may be designated as a certified authoring object with, for example, a name and description. A certified designation may be approved by an author and/or other administrator with credentials to authorize designating objects as certified. The certified authoring object may be available to any author in a given environment.

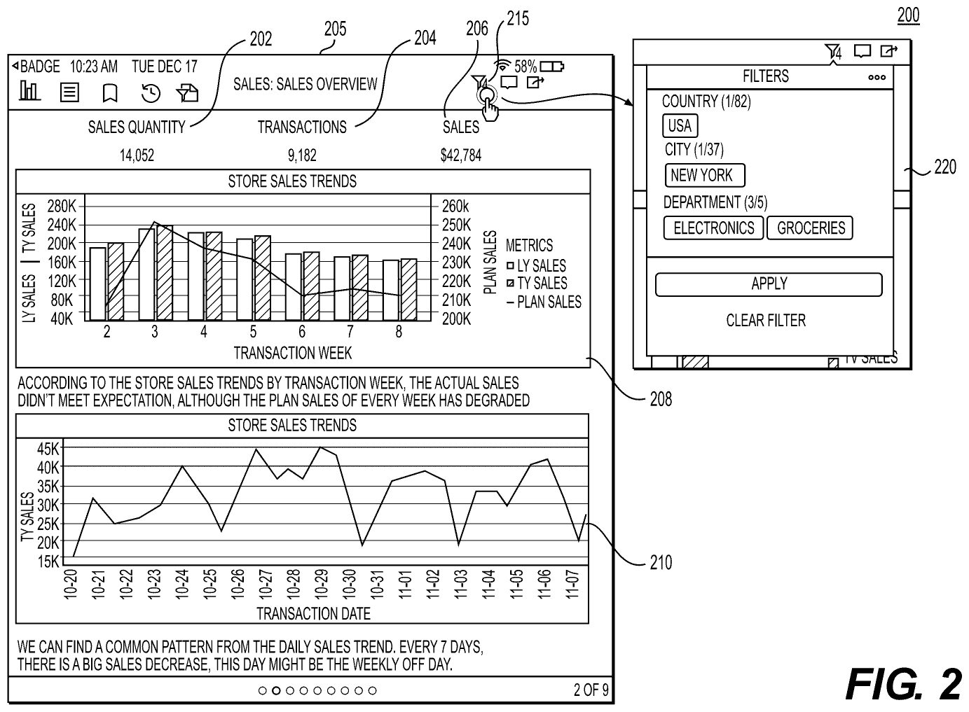

Certified objects may be added to an asset library accessible by one or more authors. Authors and/or clients may use the certified objects to create components such as visualizations, panel stacks, negations, or the like. The components may be used for multiple datasets such that use of certified objects by a client may harmonize the components used across the client's datasets and/or dossiers. FIG. 2 depicts an example information monitor editor 200 for configuring monitored contextually-relevant information, according to one aspect of the present disclosure. Editor 200 may include a data display 205. Data display 205 may be a display that aggregates data points from a variety of sources and displays them on the client device 105. The data display 205 may be, for example, a dossier and display analytics data related to sales of goods, services or items. The display 205 may include data points related to quantity of sales (202), number of transactions (204), and/or monetary value of sales (206). The display 205 may further include a display of trend graphs based on the analytics data. For example, trend graph 208 may display number of transactions per week, and trend graph 210 may be displaying number of transaction per date. The trend graphs 208 and 210 may be user-configurable and may display any relevant trending graphs as selected by the user. The display 205 may also include user-selectable icons, such as data filter icon 215. The user may select the data filter icon 215 to configure the filter settings of the analytics data displayed in display 205. Upon selecting the data filter icon 215, the filter settings window 220 may be displayed to the user. The user may filter the data by country, city, and department (e.g., electronics, groceries, etc.). The available filter setting displayed in the settings window 220 may be based on the analytics data and may differ between different data points. The user may then select to apply the selected filters or clear all selected filters. The display 205 may refresh data displayed based on the user's interaction with the filter settings window 220. For example, the sales data displayed in display 205 are directed to the sales data from the electronics and groceries department of a store located in the city of New York in the United States.

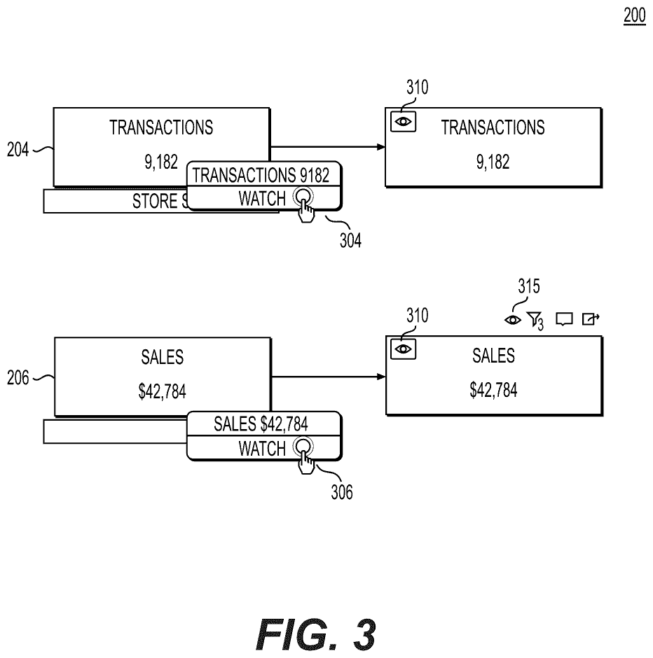

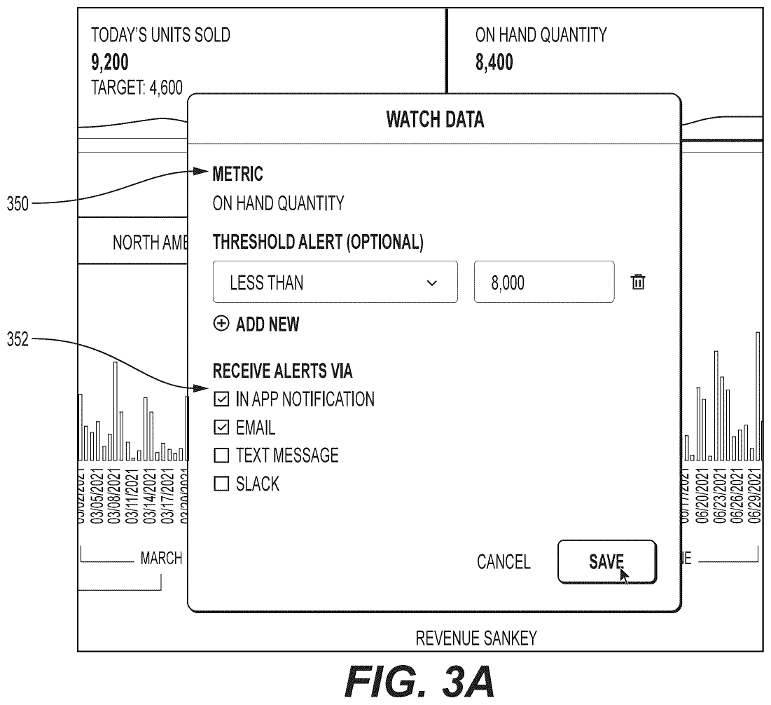

FIG. 3 depicts another example of the information monitor editor 200 for configuring monitored contextually-relevant information, according to one aspect of the present disclosure. The information monitor editor 200 may allow the user to select specific data points to construct an information monitor. The user may interact with a specific data point via a mouse input or a gesture input to indicate a desire to monitor the specific data point. For example, the user may interact with the transaction data point 204 via mouse input (e.g., clicking a mouse button) or via gesture input (e.g., touching, and/or touching and holding) and a menu 304 may be displayed to the user for the user to select monitoring of the transactions data. Upon selection of monitoring the transaction data, the editor 200 may display an icon 310 in the display field of the data point to indicate to the user that the specific data point is selected to be monitored. In another embodiment, the editor 200 may highlight or color code the display field of the data point to indicate to the user that the specific data point is selected to be monitored. The user may also select to monitoring a plurality of data points. For example, in addition to monitoring the transaction data point 204, the user may also interact with the sales data point 206 and select to monitor the sales data via menu 306. The editor 200 may then also display an icon 310 or may highlight or color code the display field of the sales data point 206 to indicate to the user that the specific data point is selected to be monitored. Upon selection of one or more data points to be monitored, the editor 200 may also display an icon 315 in the display 205 to indicate that one or more data fields in the display 205 is selected to be monitored. The selected data points to be monitored, e.g., the transaction data point 204 and the sales data point 206, may also follow the filter setting configured in settings window 220. For example, only the number of transactions and the monetary value of sales from the electronics and groceries department of a store located in the city of New York in the United States are configured to be monitored.

FIG. 3A depicts an example data threshold selector 350. As shown in FIG. 3, a monitor editor 200 may allow the user to select specific data points to construct an information monitor. The user may interact with a specific data point via a mouse input or a gesture input to indicate a desire to monitor the specific data point. Threshold selector 350 of FIG. 3A may allow the user to select a data threshold value such that one or more alerts 352 may be generated based on the given data meeting a threshold value associated with the data. The threshold value may be automatically generated by, for example, a machine learning model that receives, as input, the data point selected by the user. The machine learning model may output threshold value options (e.g., via a drop down list) form which a user may select at threshold value. The threshold may be greater than, less than, a percentage of, a delta, or the like, in reference to the data point (e.g., in comparison to a current, or given point in time).

The machine learning model may be trained to generate output one or more threshold values based on machine learning model training. The machine learning model training may be implemented using actual or simulated cohort data and/or past entity data. The cohort data and/or past entity data may include, for example, tags that may be used to train the machine learning model. The cohort data, past entity data, and/or tags may provide an indication of applicable threshold values based on events associated with the data. For example, the events may include an action taken or item viewed as a result of data meeting a certain value (e.g., a threshold value).

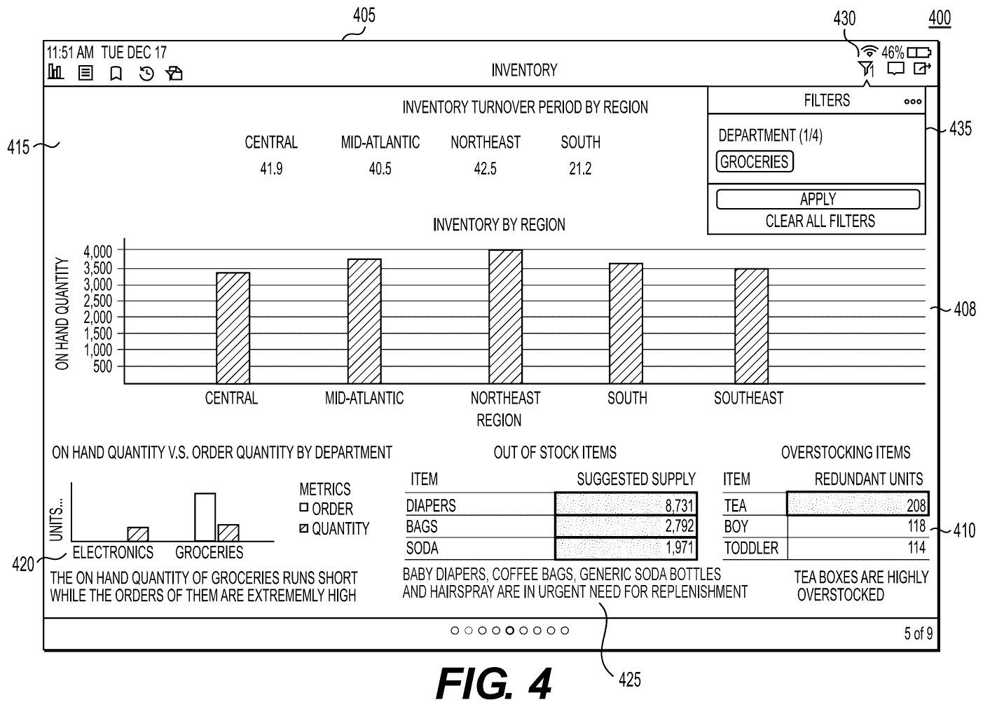

FIG. 4 depicts an example information monitor editor 400 for configuring monitored contextually-relevant information, according to one aspect of the present disclosure. Editor 400 may perform some or all of the same functions as editor 200 discussed above. Editor 400 may include a data display 405. Data display 405 may be a display that aggregates data points from a variety of sources and displays them on the client device 105. The data display 405 may for example, be a dossier and display analytics data related to inventory of goods, services or items. The display 405 may include data points related to inventory turnover period by region (415). The display 405 may further include a display of trend graphs based on the analytics data. For example, trend graph 408 may display a quantity of inventory by region, trend graph 410 may display the number of overstocking items, trend graph 425 may display the out-of-stock items, and trend graph 420 may display a quantity of items in stock vs quantity of items on order. The trend graphs 408, 410, 420, and 425 may be user configurable and may display any relevant trending graphs as selected by the user. The display 405 may also include user-selectable icons, such as data filter icon 430. The user may select the data filter icon 430 to configure the filter settings of the analytics data displayed in display 405. Upon selecting the data filer icon 430, the filter settings window 435 may be displayed to the user. The user may filter the data by department (e.g., groceries, etc.). The available filter setting displayed in the settings window 435 may be based on the analytics data and may differ between different data points. The user may then select to apply the selected filters or clear all selected filters. The display 405 may refresh data displayed based on the user's interaction with the filter settings window 435. For example, the inventory data displayed in display 405 are directed to the inventory data from the groceries department of stores located in different regions.

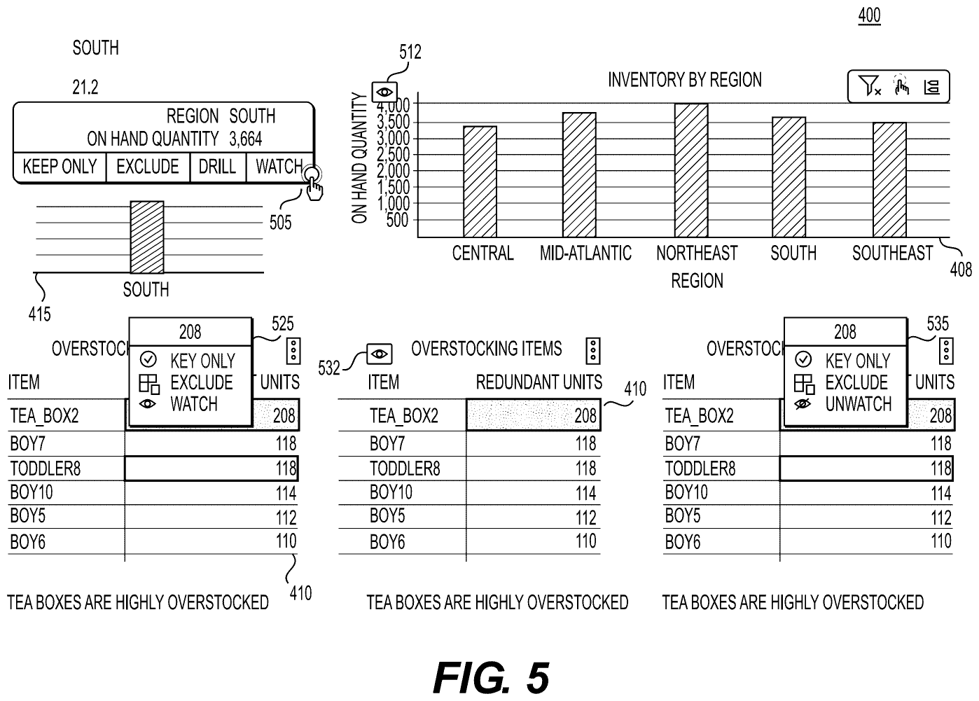

FIG. 5 depicts another example of the information monitor editor 400 for configuring monitored contextually-relevant information, according to one aspect of the present disclosure. The information monitor editor 400 may allow the user to select specific data points to construct an information monitor. The user may interact with a specific data point via a mouse input or a gesture input to indicate a desire to monitor the specific data point. For example, the user may interact with the inventory by region data point 415 via mouse input (e.g., clicking a mouse button) or via gesture input (e.g., touching, and/or touching and holding) and a menu 505 may be displayed to the user for the user to select monitoring of the transactions data. Upon selection of monitoring the inventory data, the editor 400 may display an icon 512 in the display field of the data point to indicate to the user that the specific data point is selected to be monitored. In another embodiment, the editor 400 may highlight or color code the display field of the data point to indicate to the user that the specific data point is selected to be monitored. The user may also select to monitor a plurality of data points. For example, in addition to monitoring the region data point 415, the user may also interact with the overstocking items data point based trend graph 410 and select to monitor the overstocking items data via menu 525. The editor 400 may then also display an icon 532 or may highlight or color code the display field of the overstocking items data point based trend graph 410 to indicate to the user that the specific data point is selected to be monitored. Upon selection of one or more data points to be monitored, the editor 400 may also allow the user to stop monitoring monitored data. The user may interact with the data point or the data point display field via mouse input (e.g., clicking a mouse button) or via gesture input (e.g., touching, and/or touching and holding) and a menu 535 may be displayed to the user for the user to select to stop monitoring of the monitored data. The option to stop monitoring of the monitored data may only be available when the user interacts with a data point that has been selected by the user to be monitored.

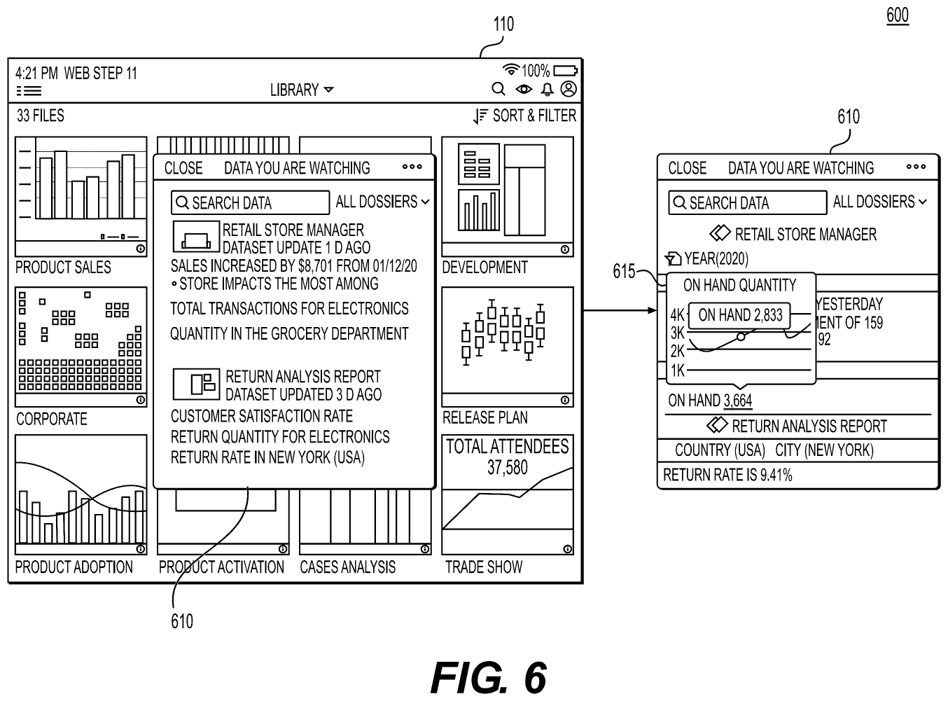

FIG. 6 depicts example design functionalities for displaying monitored contextually-relevant information, according to one aspect of the present disclosure. As shown in display 600 of FIG. 6, the application 110 may display a collection of data points. For example, the application 110 may be a library with a collection of dossiers, and each dossier may be a collection of analytics data or analytics graphs, such as data points. The application 110 may also display the monitored contextually-relevant data selected by the user from multiple dossiers as discussed above. The application 110 may present all of the monitored contextually-relevant data in one display, such as watched data display 610. Watched data display 610 provides a convenient place for users to monitor data selected from various data points. For example, the watch data display 610 may display monitored data related to sales of goods or items and inventory data of the goods or items. The user may also interact with the data points from the watch data display 610 and a trend graph of the data point may be displayed to the user in graph 615. The data points included in the watched data display 610 may be updated by the application 110 in predetermined time intervals or every time the watched data display 610 is presented to the user. The user may also manually refresh the watch data display 610 to refresh the data points included in the display. Therefore the data presented in the watch data display 610 may be the most up to date data available to the user.

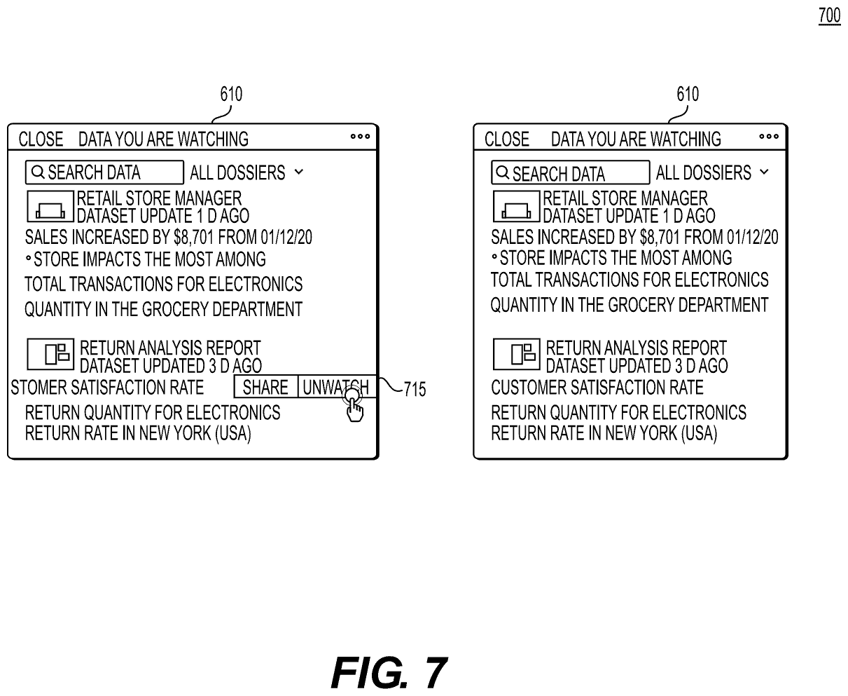

FIG. 7 depicts another example design functionalities for displaying monitored contextually-relevant information via a display 700, according to one aspect of the present disclosure. The user may perform actions to the monitored data points in the watched data display 610, such as deciding to no longer monitor a certain data point. The user may perform a gesture via mouse input (e.g., clicking a mouse button) or via gesture input (e.g., touching, and/or touching and holding) on the specific data point and options menu 715 may be displayed to the user. The user may then select to share the specific data point or unwatch the specific data point. If the user selects to unwatch the specific data point, then the data point may be removed from the selection of the monitored data points and from the watch data display 610 and updates to the specific data point may no longer be displayed to the user. Other options may also be included in the options menu 715 as desired by the user or by an administrator creating the watch data display 610.

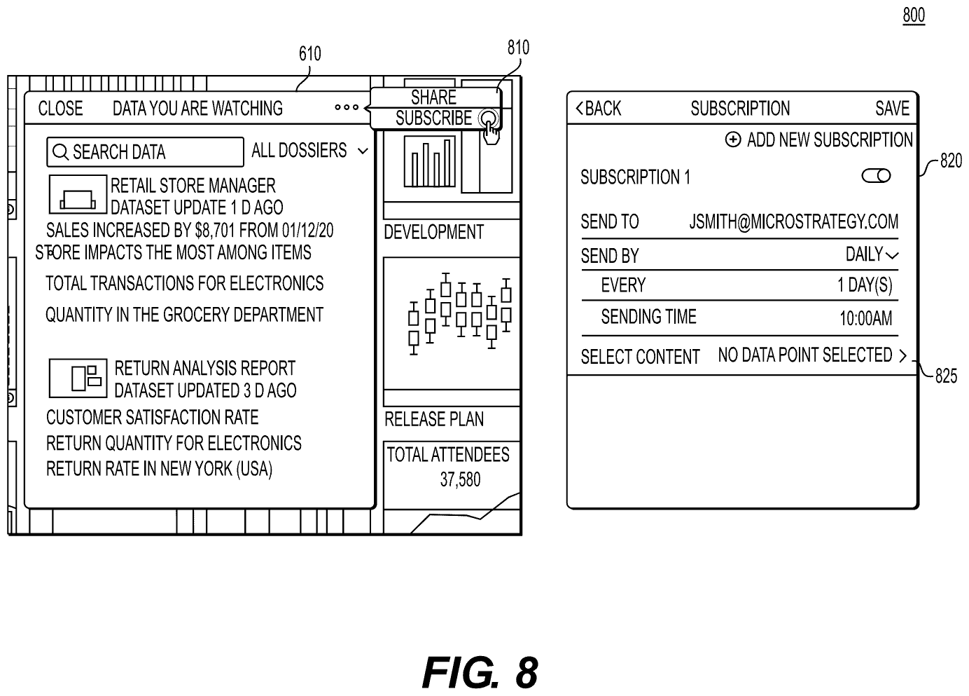

FIG. 8 depicts example subscription functionalities for displaying monitored contextually-relevant information, via a display 800, according to one aspect of the present disclosure. As disclosed above, the watch data display 610 may be displayed to the user when the user opens application 110. However, the user may have other options to access the selected monitored data points. The user may set up a subscription to the monitored data points and updates to the monitored data points may be delivered to the user at specific intervals. The updates to the monitored data points may be delivered to the user via email, text message, or application notification, or via any other appropriate format. To configure the subscription function, the user may interact with the watch data display 610 via mouse input (e.g., clicking a mouse button) or via gesture input (e.g., touching, and/or touching and holding) and a settings window 810 may be displayed to the user. The user may select to share the monitored data or subscribe to the monitored data. Upon selecting the subscribe option in settings window 810, the subscription settings 820 may be displayed to the user. The subscription settings 820 may allow the user to configure the destination of the delivery of the subscription, the specific time or interval to deliver the subscription, and specific monitored data points to subscribe to. The user may configure the specific monitored data points for subscription via content selection option 825.

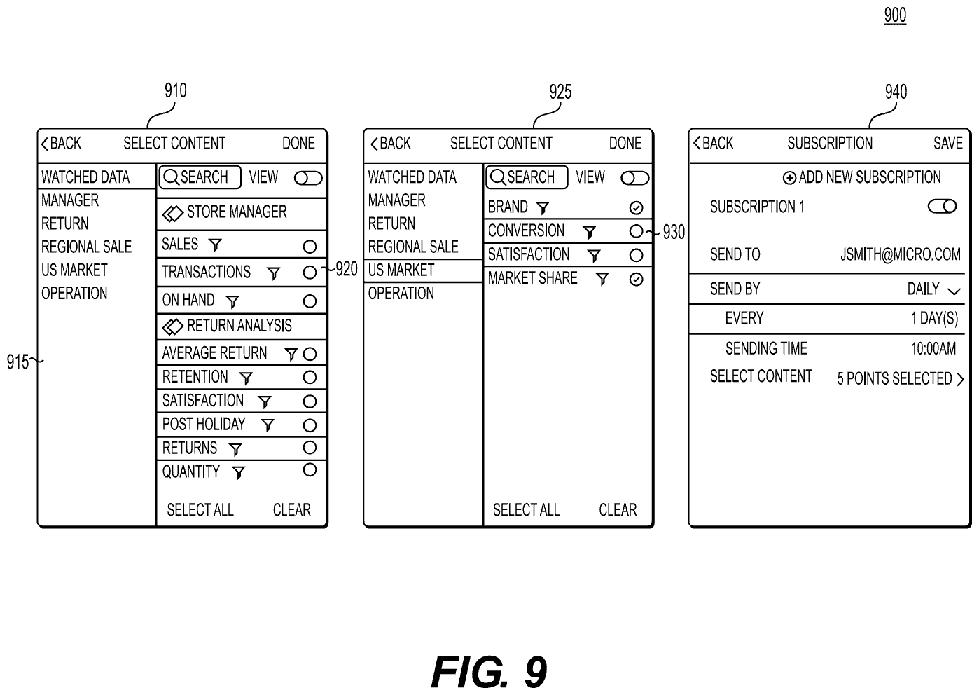

FIG. 9 depicts another example subscription functionalities for displaying monitored contextually-relevant information, via a display 900, according to one aspect of the present disclosure. Upon selecting the content section option 825, the content selection window 910 may be displayed to the user to configure specific monitored data points to subscribe to. The content selection window 910 may include category window 915 and data point selection window 920. The user may select a specific category of data points from category window 915, and the available data points of the selected category will be displayed in window 920. The user may select all of the available data points or specific data points from window 920. The user may also search for specific data points instead of selecting from the list displayed in window 920. The content selection window 925 may depict example monitored data points selected by the user, as indicated by the selected data points “BRAND” and “MARKET SHARE.” The user may interact with the selected data points to de-select the data points. After selecting the monitored data points, the user may be returned to the subscription settings 940. The subscription settings 940 may reflect the number of monitored data points selected by the user as part of the subscription.

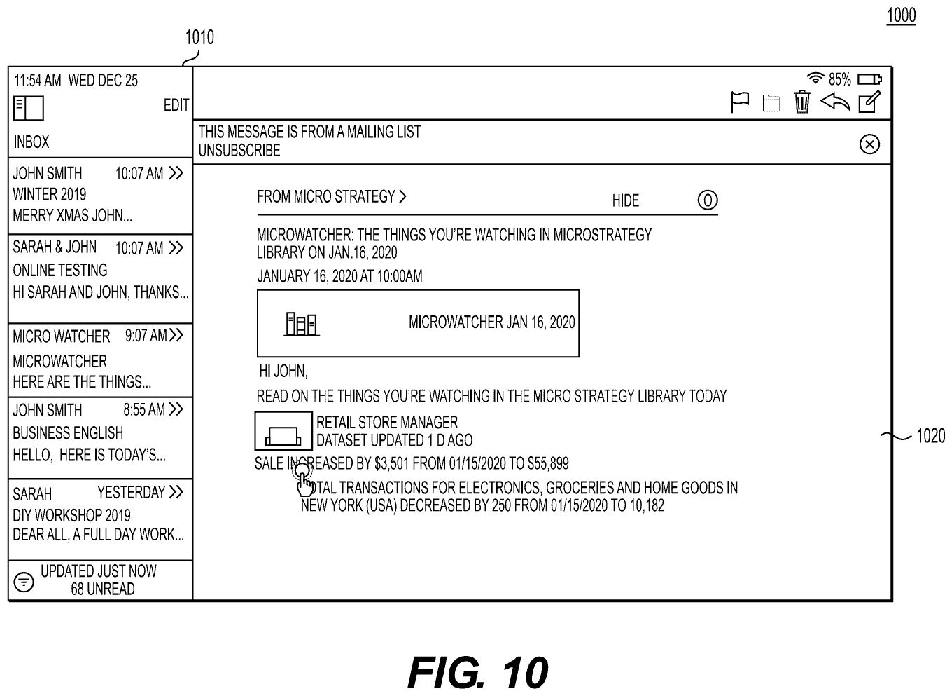

FIG. 10 depicts example user interface 1000 of the subscription for displaying monitored contextually-relevant information, according to one aspect of the present disclosure. Interface 1000 may be an email interface including an email list window 1010 and email view window 1020. Interface 1000 may be an example of subscribed monitored data points delivered to the user via email. The subscription may be viewed as part of an email in the email view window 1020. The user may interact with the information displayed in the subscription displayed in window 1020 and be directed to the watch data display 610 to view all of the monitored data points.

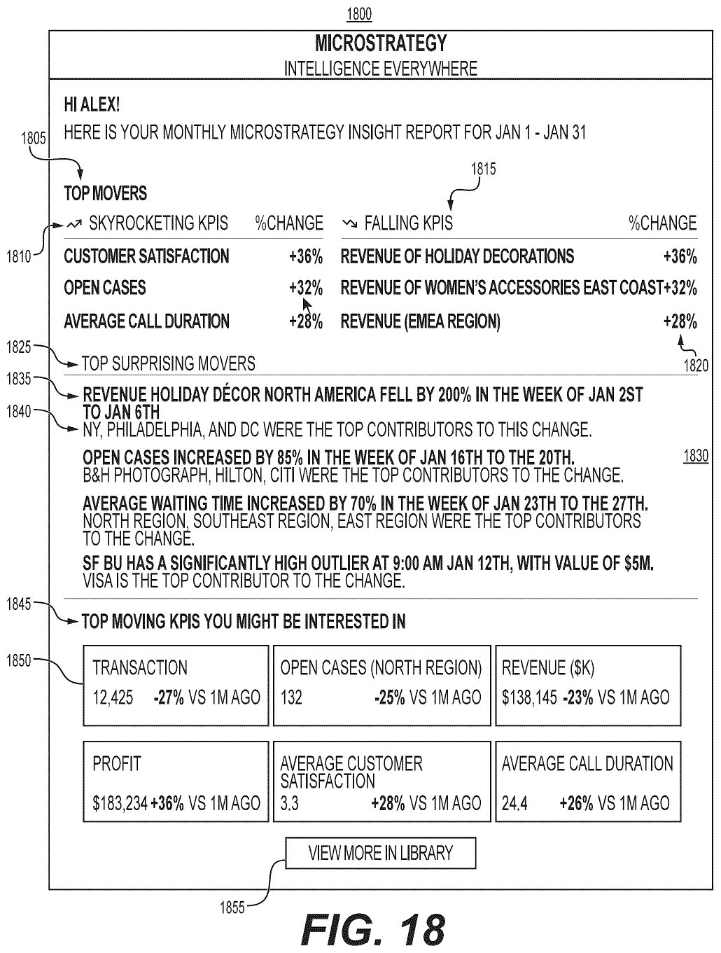

The subscription may include a scheduled summary communication of insights that may be of particular interest to a user. FIG. 18 depicts such a user insight summary email 1800, according to one aspect of the present disclosure. As shown in FIG. 18, a user insight summary email 1800 may include, for example, a section 1805 presenting information about top movers among key performance indicators (KPIs) the user has subscribed to, such as a list of increasing, or “skyrocketing” KPIs 1810 and a list of falling KPIs 1815. Each list of KPIs may include information about multiple individual KPIs 1820, including, for example, an identifier and a percentage change. The number of KPIs listed and a threshold for determining which KPIs are listed, based on, for example, percentage change, may be determined based on user preferences. In addition, user insight summary email 1800 may include, for example, a section 1825 presenting information about top surprising movers among all KPIs. The list of surprising movers may be determined, for example, based on KPIs having values that are outliers according to past and/or future trends. Each “surprising mover” KPI 1830 may include information about the listed KPI including, for example, NLG text 1835 describing the KPI and a list of key contributors 1840 to the KPI. Further, user insight summary email 1800 may include, for example, a section 1845 presenting information about recommended top movers among KPIs the user has not subscribed to. The top movers among KPIs the user has not subscribed to may be presented as insights 1850 for each such KPI. A user interface control 1855 may be provided to allow the user to switch to a view of their library application 110 to view more information about the KPIs represented in sections 1805, 1825, or 1845. In addition, each of the KPIs or insights presented in user insight summary email 1800 may include a hyperlink or other embedded user interface control to quickly view a dossier for the underlying KPI or insight.

Thresholds for determining which KPIs and/or insights are to be displayed in sections 1805, 1825, or 1845 may be selected or adjusted by a user. Initial thresholds may be set as system defaults, may be set or adjusted by an administrator or an owner of the KPI or insight, or may be determined by an artificial intelligence operation based on past KPI data, such as by a machine learning algorithm.

Although user insight summary email 1800 is depicted as being presented via an email application, other channels, such as social media channels, team workflow channels, text messaging channels, etc., may also be used. A schedule for delivering such a summary may be set by a user or by an administrator. Alternatively, sending of a summary email may be triggered according to user-specified triggers, such as, for example, ranges or thresholds for KPIs or KPI outliers, or may be determined by an artificial intelligence operation based on past KPI data, such as by a machine learning algorithm.

In addition to KPIs recommended to a user via a summary email, such as described with respect to FIG. 18, the application 110 may recommend KPIs to be watched by a user. Such a recommendation may be determined, for example, through analysis of KPIs that are watched by other users. As discussed above, a user may elect to watch a KPI, such as a data point, through a user interface. The selected watched elements may create, for example, objects in metadata for the watched elements and/or the user, such as in the form of a bookmark, subscription, or other metadata. The metadata may include, for example, user-defined filter conditions, a user-applied name, user-defined thresholds, user-defined visualization settings, such as, for example, color indicators. A subscription for the watched KPI may include a link to a dossier such that the dossier related to the KPI is periodically presented to the user. Application 110 may determine that a number of users are watching the same KPI in a similar way. The similarity may be based on users watching the same KPI, watching the same KPI in the same dossier, watching the same KPI with the same filter and/or threshold settings. Application 110 or any applicable component (e.g., as discussed in reference to environment 100) may generate a watch score based on KPIs watched by other users, selected watched elements, number of subscriptions, rate of KPIs being watched and/or subscriptions, etc.). A recommendation may be determined, for example, based on the watch score exceeding a threshold watch score for a given KPI or subscription.

Application 110 may further track the watched KPIs and watching users based on attributes of the users, such as, for example, the role of the users, group membership of the users within an organization, security level of the users, seniority of the users, etc. Users determined to be watching KPIs in a similar way may be formed into groups of such users. Group membership of the users may further be determined based on, for example, use of the same or similar library applications. That is, application 110 may track the number of users watching a KPI, attributes of those users, and how the users are watching that KPI. Based on analysis, application 110 may determine that certain KPIs and or dossiers would be of interest to users with similar attributes. For example, application 110 may determine that a targeted user, such as a new user entering an organization, would be affiliated with one or more groups of users determined to be watching KPIs in a similar way. The determined KPIs/dossiers may then be recommended to additional users, such as, for example, a new user added to the system, a user changing roles or group membership, or other users matching the similar attributes but not currently watching the KPI/dossier. Recommendations may include all determined KPIs/dossiers, or the recommendations may be limited by other facts such as the security clearance of the new/additional user, the certification of the dossier, explicit exclusion of certain KPIs/dossiers by a user, author, or administrator, etc. When a new user enters the system, or a qualifying user attribute change occurs, the user may automatically receive a set of KPIs/dossiers that are determined to be of interest to the user.

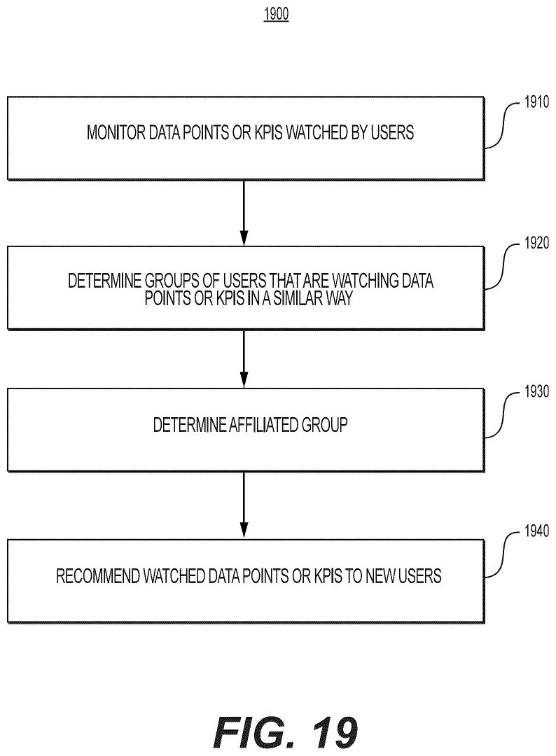

FIG. 19 is a flow chart 1900 of an example method of recommending insights to users, such as by the process described above, according to one aspect of the present disclosure. As shown in FIG. 19, at operation 1910, application 110 may monitor data points or KPIs watched by users, such as by the means described above. At operation 1920, application 110 may determine groups of users that are watching data points or KPIs in a similar way, such as by the means described above (e.g., using a watch score and/or watch score threshold). At operation 1930, application 110 may determine an affiliated group for a new user. At operation 1940, application 110 may recommend watched data points or KPIs to new user based on the affiliated group, such as by the means described above. Although flow chart 1900 includes an example of a new user, it will be understood that the techniques disclosed herein may be applied to existing users (e.g., based on a change to an existing user profile, position, action, etc.).

In addition to KPIs/dossiers automatically recommended to users based on KPIs watched by other users, a user, acting as an author, may target dossiers or user experiences to specific users or groups of users. For example, the user may create a user experience based on a set of KPIs and designed visualizations. The created user experience may then be provided to the targeted group of users. The group of targeted users may be determined by the user authoring the created experience or may be recommended to the authoring user by application 110, such by any of the methods discussed above for determining recommended KPIs/dossiers for particular users. Alternatively, application 110 may automatically select the group of targeted users and provide the created user experience to the targeted users without any action by the authoring user. For example, the authoring user may target the created user experience to a “CxO” user group (i.e., the CEO, CFO, etc. of an organization). For example, application 110 may synchronize with an organization's organizational structure to determine the membership of the targeted user group. The set of users receiving the created user experience may change over time as users performing the roles in the selected user group change. Application 110 may monitor membership of the targeted user group to update the users receiving the created user experience. For example, a new user entering the CFO role would begin receiving the created user experience based on their update membership in the “CxO” user group. Alternatively, the authoring user may target an ad hoc group of users based on the authoring user's perceptions or understanding of each user's interests or potential interests. Application 110 may then recommend additional users to receive the created user experience based on the roles, watched KPIs, subscriptions, or other user profile data of the targeted users and the recommended additional users. The group of users targeted to receive the created user experience may be updated based on the recommendation. Such an update may be performed manually, such as by the authoring user or an administrator, or may be performed automatically by application 110. The determination of whether such updates are performed automatically may be according to the policies or preferences of the organization.

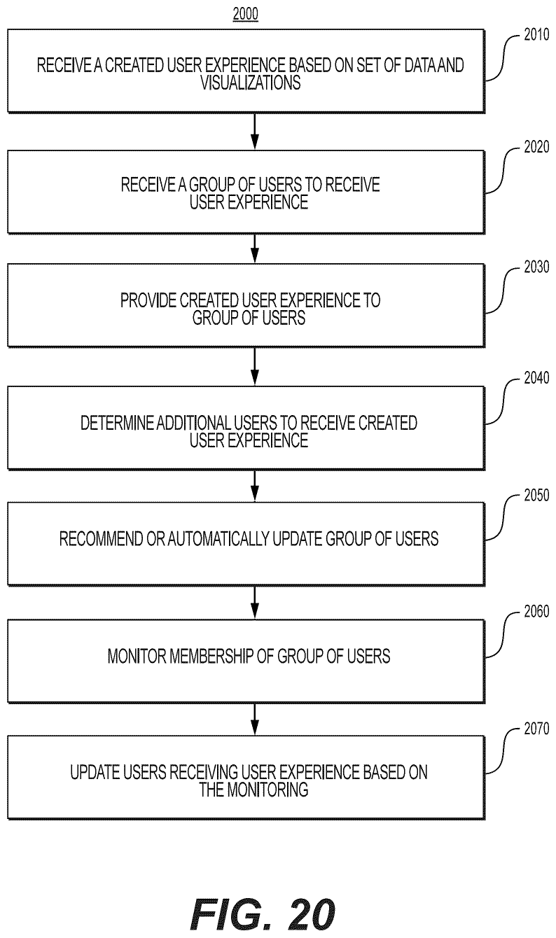

FIG. 20 is a flow chart 2000 of an example method of providing user experiences to users, according to one aspect of the present disclosure. As shown in FIG. 20, at operation 2010, application 110 may receive a created user experience based on set of KPIs and visualizations, such as by the means described above. At operation 2020, application 110 may receive a group of users to receive the created user experience, such as may be determined by the means described above. At operation 2030, application 110 may provide the created user experience to a group of users, such as by the means described above. At operation 2040, application 110 may determine additional users to receive the created user experience, such as by the means described above. At operation 2050, application 110 may recommend or automatically apply an update to the group of users, such as by the means described above. At operation 2060, application 110 may monitor the membership of the group of users, such as by the means described above. At operation 2070, application 110 may update the users receiving the created user experience based on the monitoring, such as by the means described above.

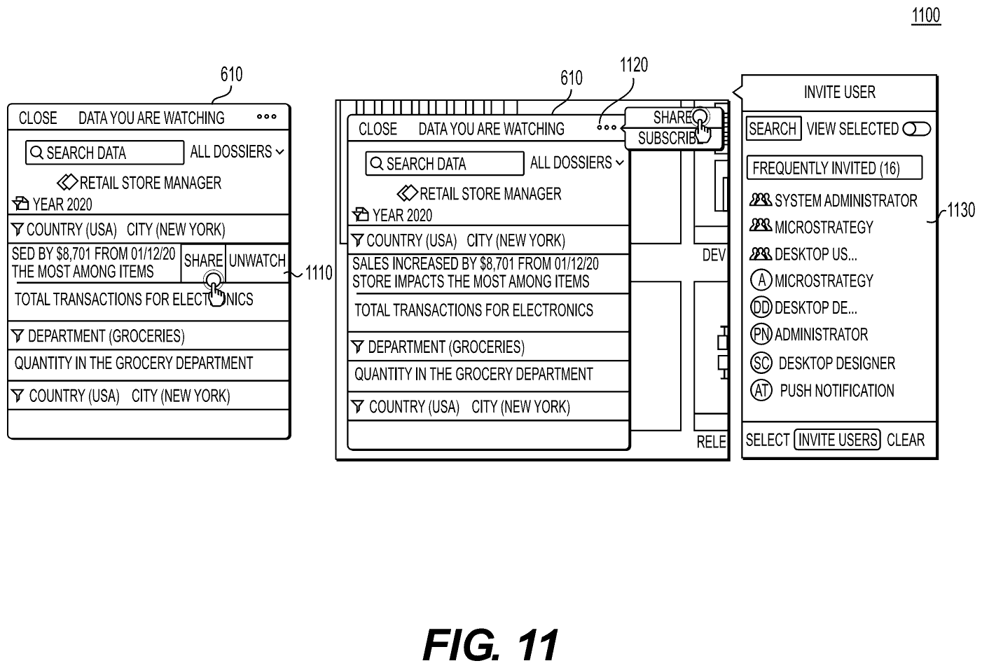

FIG. 11 depicts an example sharing functionalities for displaying monitored contextually-relevant information via display 1100, according to one aspect of the present disclosure. The users may also configure the monitored data points to be shared with other users. The user may interact with a specific data point in the watch data display 610 via mouse input (e.g., clicking a mouse button) or via gesture input (e.g., touching, swiping, and/or touching and holding) and a settings window 1110 may be displayed to the user. The user may select the share option to begin the configuration of the sharing function. In another embodiment, the user may configure to share the complete collection of monitored data points. The user may interact with the settings 1120 of the watch data display 610 via mouse input (e.g., clicking a mouse button) or via gesture input (e.g., touching, and/or touching and holding). The user may select the share option to begin the configuration of the sharing function. Once the sharing function is selected via the settings window 1110 or the settings 1120, the sharing user selection window 1130 may be displayed to the user. The user may select individual people, groups of people, or organizations to share the monitored data points. In addition, the user may search for specific people, groups of people, or organizations to share the monitored data points.

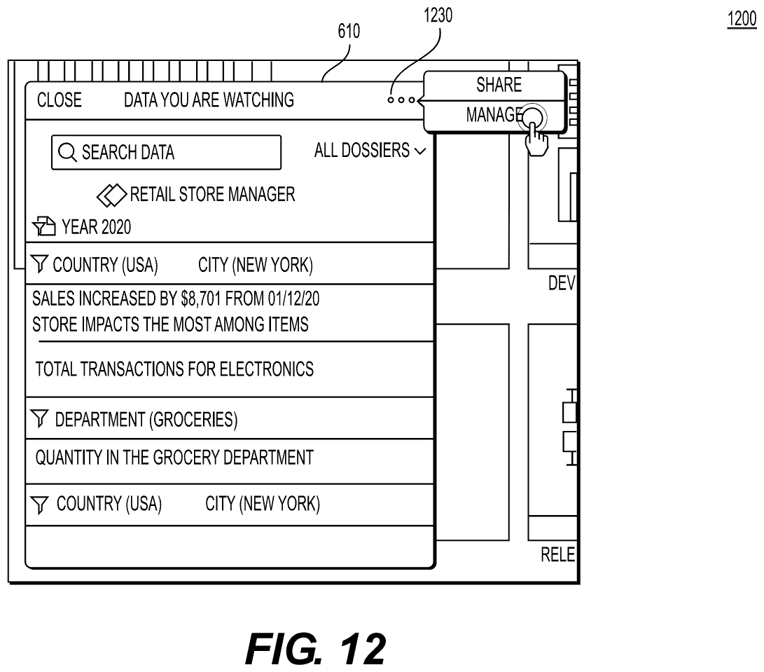

FIG. 12 depicts an example managing functionality for displaying monitored contextually-relevant information via display 1200, according to one aspect of the present disclosure. Once a subscription of monitored data points have been created, the user may be able to configure the subscription settings. The user may interact with the watch data display 610 via mouse input (e.g., clicking a mouse button) or via gesture input (e.g., touching, swiping, and/or touching and holding) and a settings window 1230 may be displayed to the user. The user may select the manage option to begin the configuration of the subscription settings. Upon selecting the manage option, the user may then be able to configure the number of data points selected to be monitored, the destination of the delivery of the subscription, the specific time or interval to deliver the subscription, the parties sharing the subscription, and/or any other configuration settings.

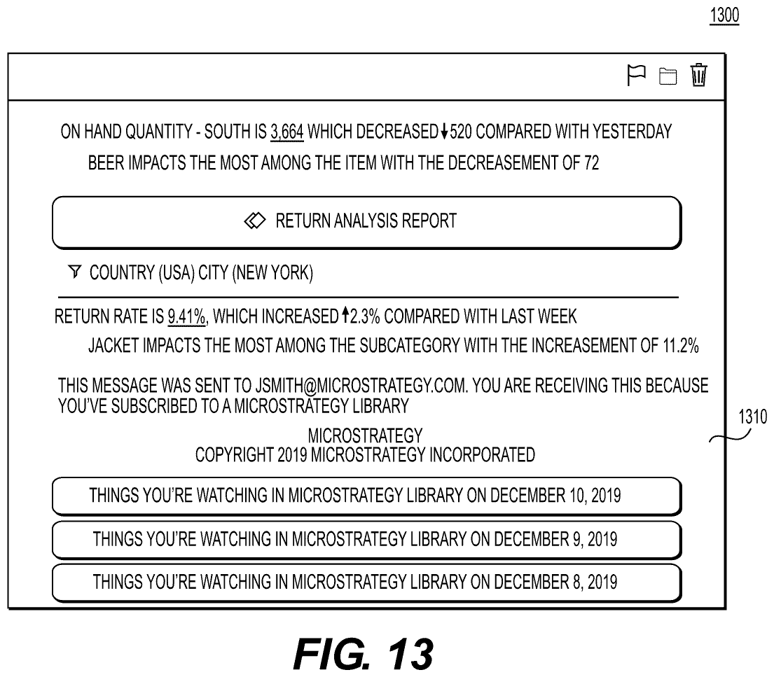

FIG. 13 depicts an example interface 1300 of monitored contextually-relevant information, according to one aspect of the present disclosure. Interface 1300 may be a text message display, an email client display, an application display, or the like. The interface 1300 may be an example of subscribed monitored data points delivered to the user and may display the updated monitored data points in section 1310. The delivered monitored data points may also include a history of the monitored data points' subscriptions, for example as an attachment, or a HTML link (e.g., as a histogram). The user may interact with the history of the monitored data points subscriptions and be directed to the watch data display 610 to view all of the monitored data points. The number of historical monitored data points subscriptions included may be configurable by the user, for example using the manage option discussed above with regards to FIG. 12.

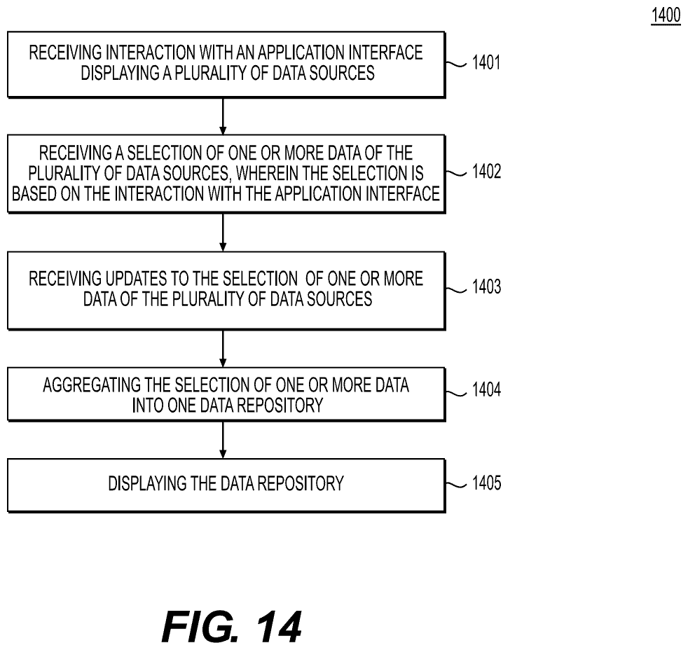

FIG. 14 is a flow chart 1400 of an example method of monitoring contextually-relevant information, according to one aspect of the present disclosure. The flow chart 1400 may begin at step 1401 by receiving an interaction with an application interface displaying a plurality of data sources. At step 1402, a selection of one or more data of the plurality of data sources may be received. The selection of the data may be based on the interaction with the application interface. At step 1403, updates to the selection of the one or more data of the plurality of data sources may be received. At step 1404, the selection of the one or more data may be aggregated into one data repository. At step 1405, the data repository may be displayed to the user.

According to an implementation of the disclosed subject matter, a central page may provide a live model of selected data and/or corresponding insights generated from the selected data. For example, a selection of one or more data of the plurality of available data may be received at 1402 of FIG. 14. The selection may be from a plurality of different data sources that a user interacts with. An author may authorize a plurality of insights for the given client. The plurality of insights may be generated for application to a client's datasets, as further disclosed herein.

A machine learning model or user may select all or a subset of available insights based on the selected data. The insights may, for example, correlate changes in the selected data, the causes for the changes, and/or the results associated with the changes. For example, an insight may correlate the increase in sales of a given widget at a first store, based on a threshold temperature change exhibited at the location of the store. The insight may further predict similar changes in sales of the given widget at the first store or one or more second stores based on the change at the first store.

A live model page may be provided to the user and may include multiple visualizations generated based on selected insights as well as one or more insights selected for different data. The live model page and its corresponding visualizations may be updated in real time or near real time, based on changes to the underlying data (e.g., to a semantic architecture). According to an implementation, one or more additional visualizations may be generated at the live model page, based on a change in data that results in a new or updated insight.

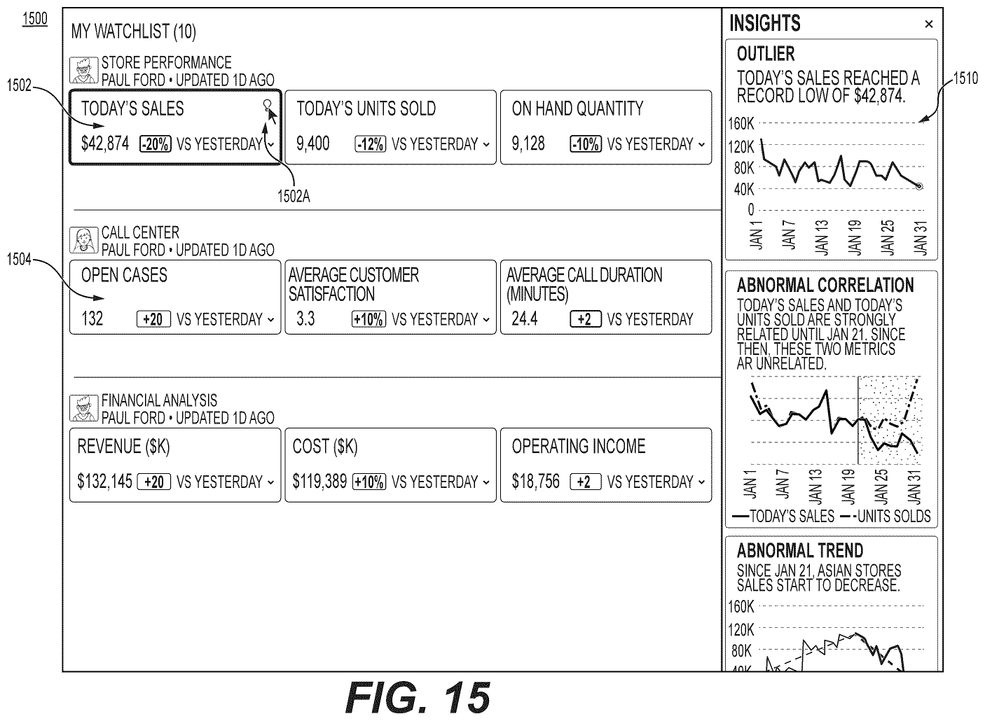

According to an implementation, insights may be generated based on datasets, historical application of data within datasets, dimensions of a dataset and one or more other datasets, or the like. The insights may be generated by an engine (e.g., using one or more machine learning models) based on one or more client datasets, combination of dimensions, one or more visualizations used by a user, or the like. Insights may be generated, for example, based on two or more datasets having the same dimensions or commonalities between data across the same dimensions. For example, FIG. 15 shows a live model page 1500 including a plurality of data points (e.g., 1502, 1504) being monitored across different platforms for a given client. The data points may be monitored based on user selection of the respective data. As shown, data point 1502 may be selected from a store performance platform and may be shown in the live model page 1500 along with data appoint 1504 selected from a call center platform. Upon selection (e.g., mouse over 1502A) of data point 1502, insights 1510 and corresponding visualizations associated with data point 1502 may be provided. Insights 1510 may be previously approved by an author, as disclosed herein.

According to an implementation, an insight may be generated based on visualizations currently provided to a client or user. For example, a machine learning model may receive current visualizations as an input. The machine learning model may, based on the current visualizations, identify gaps in information (e.g., relationships (e.g., between multiple dimensions of data), correspondences, correlations, trends, etc.) that may be valuable to a client or user. The gaps and/or one or more dimensions may be applied to generate an insight. The insight may, for example, explain changes, relationships correspondences, correlations, trends, or the like for a dataset or a set of selected visualizations that bridge the gap between data presented to a user and data that may be missing but identified as useful.

According to an implementation of the disclosed subject matter, an AI platform may use, for example, one or more machine learning models to generate insights for author approval. The insights may be generated based on patterns identified by the one or more machine learning models. The patterns may identify, for example, relationships (e.g., between multiple dimensions of data), correspondences, correlations, trends, or the like or a combination thereof, which may be presented as insights. Weights and/or layers of the one or more machine learning models may be updated based on client feedback generated based on client interaction with data. Similarities or differences in data (e.g., attributes, metrics, dimensions) between multiple data sets may be used to identify and/or update the weights and/or layers as patterns are updated.

Insights may be generated based on metadata associated with datasets for a given client. The metadata may be output by a machine learning model that receives one or more datasets of the given client. For example, a client may have fifty production datasets associated with the client. The datasets may be provided to a machine learning model configured to output metadata from the fifty production datasets. The metadata may be extracted from the datasets based on, for examples, attributes, metrics, values, and/or tags associated with the datasets.

Commonalities and/or differences within the datasets or corresponding data may be used to identify insights. For example, datasets with the same or similar dimensions may be combined and analyzed in similar ways. The client may automatically receive access to author approved insights, and may generate or may be provided visualizations based on overlap or differences in the dimensions of one or more datasets. As further disclosed herein, insights may improve over time based on insight feedback provided to a machine learning model. Insight feedback may include the interaction, use, or modification of insights by users. The feedback may result in an increase, decrease, or updating of a given insight or category of insights.

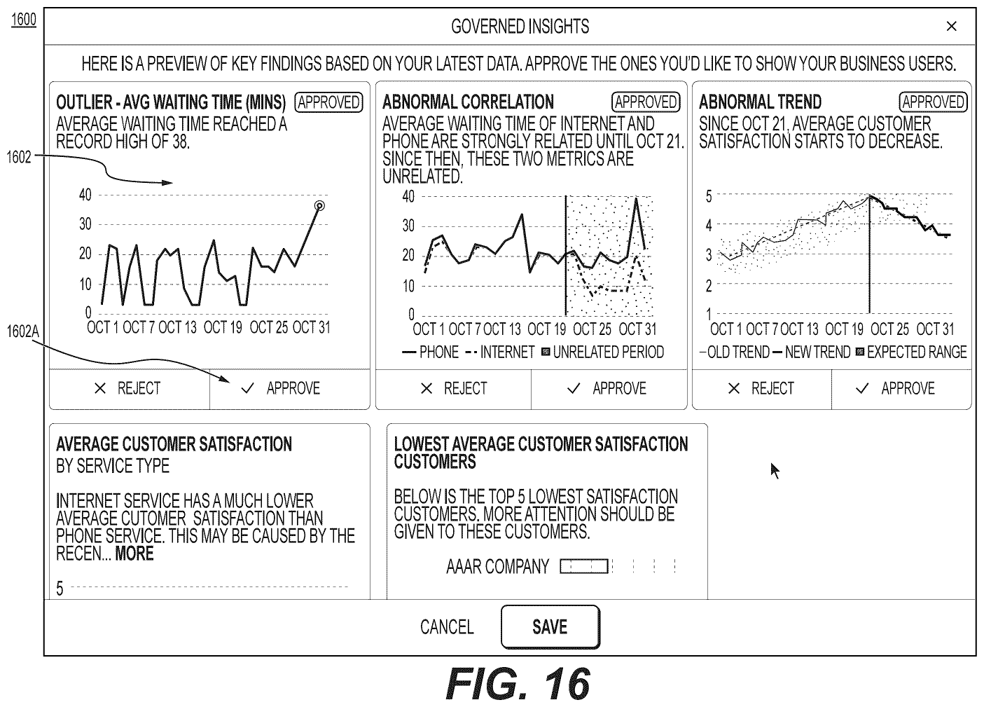

FIG. 16 shows an author approval page 1600 for an author to approve insights for use by one or more users. Based on data being tracked for a given user and/or based on one or more selected datasets, one or more insights may be presented via approval page 1600. An author may approve (e.g., via approval button 1602A) one or more insights (e.g., insight 1602). Approved insights may be presented to users as visualizations. As shown, insights (e.g., insight 1602) may include information such as a trigger for the insight (e.g., a threshold, an outliner, a correlation, a trend, an average, etc.), values or dates associated with the insight, and/or a visualization associated with the insight. Approved insights may be provided to users (e.g., as visualizations) and rejected insights may not be provided to users. As disclosed herein, insight approvals and rejections may be updated based on user feedback.

Approved insights may be made available to one or more users associated with a client (e.g., for generation of visualizations via application 110). For example, a user may select data to be monitored (e.g., at 1402 of FIG. 14). Based on the selected data and on insights approved by an author, a plurality of approved insights may be presented to the user or all users associated with a client, for the client's specific datasets. The user may be able to select one or more of the plurality of insights to generate corresponding visualizations via application 110.

A client machine learning model may receive, as inputs, client interaction with the approved insights. A client interaction may include, for example, use of a given insight (e.g., for visualization via application 110), rejection of an insight, and/or modification of an insight. The client machine learning model may output (e.g., to an author) recommendations to update the approved insights, based on the client interaction. As an example, an author may receive feedback (e.g., based on client interaction) that a given insight is declined by clients 80% of the times that it is made available. Accordingly, in subsequent iterations, the author may not approve the given insight. Alternatively, an authoring machine learning model may learn to prioritize, include, and/or remove insights based on the client feedback.

According to an implementation, NLG may be used to generate questions based on approved insights. For example, based on sales data across multiple stores, an insight may be generated for sales figures for a given widget at various store locations. The insight may correlate trends in store location, time, and sales of the widget. The insight may be provided to a client by converting the insight into one or more questions. For example, a client may be at an interface to review widget sales at a first store. The client may be provided a question, “How is this widget selling in other stores?” The client may select the question and, based on the selection, a visualization may be provided that extracts data from multiple stores at different times. The visualization may be provided to the client via application 110, in addition to the widget sales data the first store. Accordingly, the author may govern insights for use by the client, and the client may be elect to implement one or more insights via a NLG generated question.

According to an implementation, NLG may be used to present insights to users (e.g., via client device 105). NLG operations may convert an insight into a set of questions that can guide visualization generation. For example, a user may select a dataset and attributes to be displayed via a chart. The dataset may include sales data for a first location for a period of time. Based on the dataset and attributes, an approved insight that tracks similar sales data across multiple different stores may be trigger. Based on the insight, NLG may be used to generate a series of questions. For example, a first question may ask the user “Do you want to see sales data for this widget at other stores?” A second question may ask the user “Do you want to see sales data for this widget at this store at this time last year.” A third question may ask, “Do you want to see what other attributes correlate with changes to the sales data for this widget?” A user may select or interact with one or more of the questions and, based on the selection or interaction, additional visualizations may be created. Additionally, the selection or interaction may be used as feedback and may be provided to an author (e.g., via a machine learning model output). The feedback may inform future approvals of insights (e.g. if a given question nor insight is selected less than a threshold number of times, then it may not be used in the future).

According to an implementation of the disclosed subject matter, automated visualizations may be generated and presented to a client (e.g., via client device 105). The visualizations may be generated based on one or more of a selected dataset, historically selected datasets, data trends, or the like. According to an implementation, an author may determine that when a first visualization is selected, one or more additional visualizations should also be provided. The author may make the determination based on one or more insights and/or historical data indicating that, for example, users that select a first visualization often also select the one or more additional visualizations.

Alternatively, or in addition, one or more additional visualizations may be provided upon selection of a visualization. As an example, a first visualization for a given dataset may be selected for display (e.g. by a user). A machine learning model may receive the selection of the first visualization and may be trained to output one or more additional visualizations based on the selection of the first visualization. The one or more additional visualizations may be based on historical data that indicates that users that select the first visualization often select the one or more additional visualizations for display.

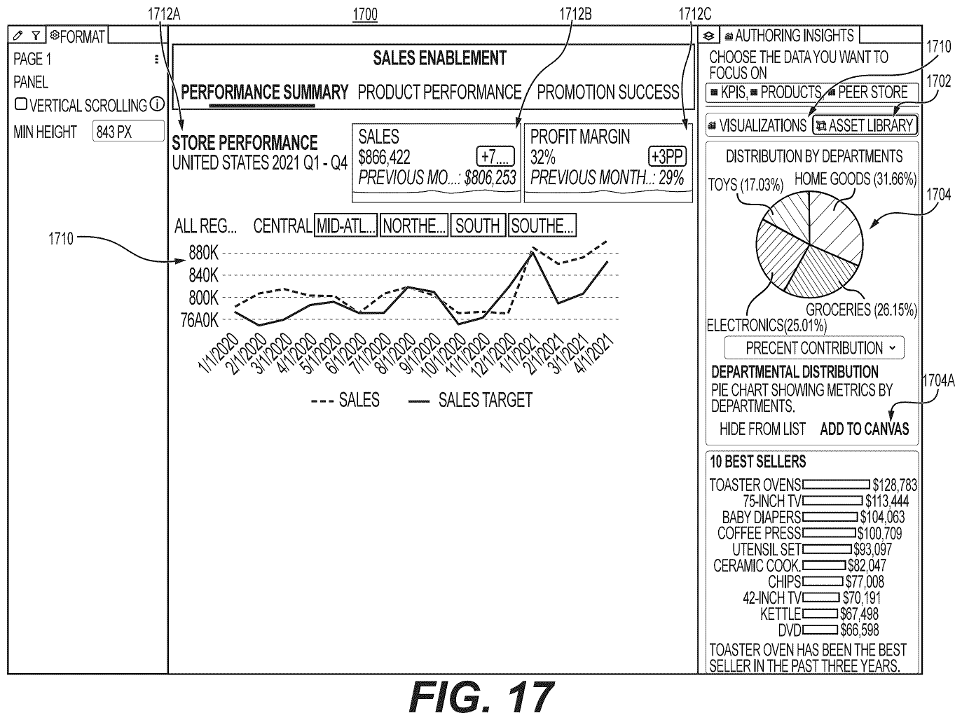

FIG. 17 shows a canvas 1700 with augmented visualization recommendations. The visualization recommendations may be from an asset library 1702. A user may be able to select a visualization 1704 by selecting an “Add to canvas” option 1704A. The selected visualization may be added to the user's canvas and may be populated with applicable data from client datasets. The visualization recommendations may be certified for use across a client such that canvases created by users associated with the client may use similar visualizations. The visualizations may include multiple components (e.g., based on one or more client datasets) and may also be generated based on commonalities between different dimensions of data. By providing automated visualizations, such as certified visualizations, a user may be able to quickly create a canvas by taking advantage of historical visualizations and/or machine learning outputs that recommend visualizations based on datasets. The visualizations provided (e.g., via asset library 1702) may be updated based on user feedback. For example, if a given visualization is recommended via the asset library and applied by users below a threshold number of times, then that visualization may be removed as a recommendation or its priority may be reduced. In the absence of certified visualizations, a visualization section 1710 may also automatically suggest visualizations (e.g., non-certified visualizations). The visualization section 1710 may automatically suggest visualizations based on a selection of one or more databases, one or more tables, one or more objects, or the like.

A certified object may be centrally updated (e.g., by an author of the certified object). Any updates to the certified object may be propagated across any uses of the certified object. For example, a user may create a canvas using a certified visualization that has a given axis range shown in a graph. The author of that certified visualization may update the certified object to update the axis range. Accordingly, upon subsequent populations of the canvas, the axis range for the graph may correspond to the updated axis range.

According to an implementation, a certified object may be prioritized over an auto-generated object (e.g., an object generated by artificial intelligence), thereby increasing consistency of design across client applications. Accordingly, for example, if a model recommends an automatically generated visualization, a determination whether a certified version of that visualization is available may be made. The determination may be made by, for example, comparing an automatically generated object to those of available certified objects. If a certified version is available, that certified version may be provided instead of a non-certified version.

According to an implementation, as shown in FIG. 17, a user may select multiple components (e.g., 1712A, 1712B, and 1712C) of a visualization. The selected components may be grouped together and saved as an asset that can be used subsequently by the user that grouped the components or by one or more other users.

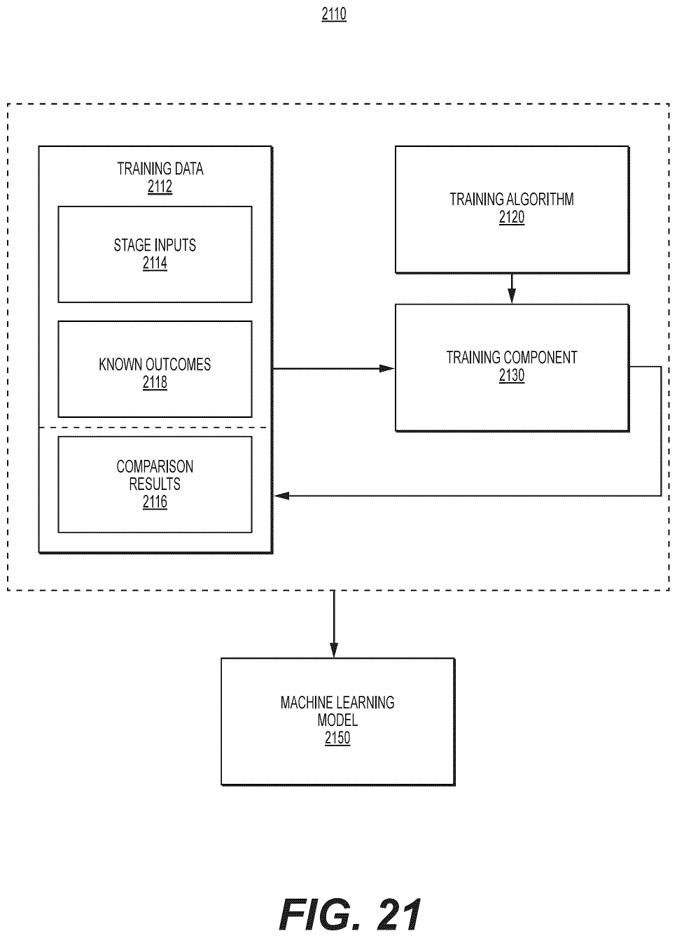

One or more implementations disclosed herein may be implemented using a machine learning model 2150 of FIG. 21. Such a machine learning model may be trained using the data flow 2110 of FIG. 21. Training data 2112 may include one or more of stage inputs 2114 and known outcomes 2118 related to a machine learning model to be trained. The stage inputs 2114 may be from any applicable source including data input or output from a component, step, or module discussed herein and/or as shown in FIGS. 1-20. The known outcomes 2118 may be included for machine learning models generated based on supervised or semi-supervised training. An unsupervised machine learning model may not be trained using known outcomes 2118. Known outcomes 2118 may include known or desired outputs for future inputs similar to or in the same category as stage inputs 2114 that do not have corresponding known outputs.

The training data 2112 and a training algorithm 2120 may be provided to a training component 2130 that may apply the training data 2112 to training algorithm 2120 to generate a machine learning model. According to an implementation, training component 2130 may be provided comparison results 2116 that compare a previous output of the corresponding machine learning model to apply the previous result to re-train the machine learning model. Comparison results 2116 may be used by training component 2130 to update the corresponding machine learning model. Training algorithm 2120 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. Training algorithm 2120 and/or the training disclosed in FIG. 21 may be used to modify one or more of weights, layers, nodes, synopsis, or the like of an initial machine learning model to generate machine learning model 2150 based on the training data 2112 and training component 2130.

A number of implementations have been described. Nevertheless, it will be understood that various modifications may be made without departing from the spirit and scope of the disclosure. For example, various forms of the flows shown above may be used, with steps re-ordered, added, or removed.

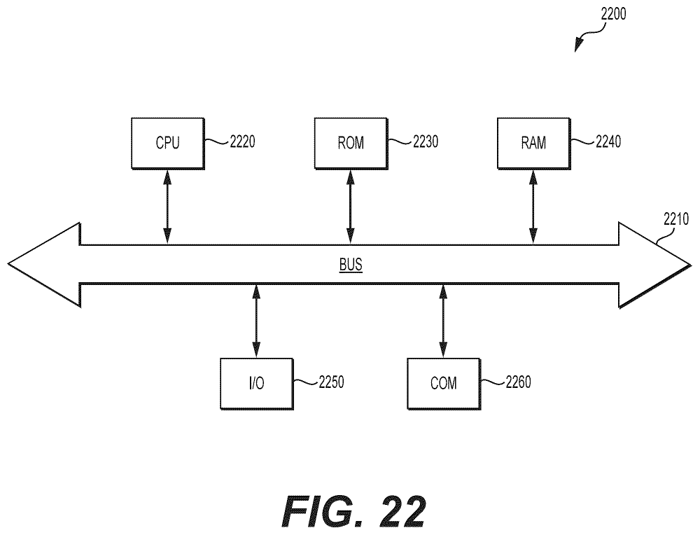

FIG. 22 depicts a high-level functional block diagram of an exemplary computer device or system, in which embodiments of the present disclosure, or portions thereof, may be implemented, e.g., as computer-readable code. Additionally, each of the exemplary computer servers, databases, user interfaces, modules, and methods described above with respect to FIGS. 1-21 can be implemented in device 2200 using hardware, software, firmware, tangible computer readable media having instructions stored thereon, or a combination thereof and may be implemented in one or more computer systems or other processing systems. Hardware, software, or any combination of such may implement each of the exemplary systems, user interfaces, and methods described above with respect to FIGS. 1-21.

If programmable logic is used, such logic may be executed on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor or a plurality of processors, or combinations thereof. Processor devices may have one or more processor “cores.”

Various embodiments of the present disclosure, as described above in the examples of FIGS. 1-21, may be implemented using device 2200. After reading this description, it will become apparent to a person skilled in the relevant art how to implement embodiments of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As shown in FIG. 22, device 2200 may include a central processing unit (CPU) 2220. CPU 2220 may be any type of processor device including, for example, any type of special purpose or a general-purpose microprocessor device. As will be appreciated by persons skilled in the relevant art, CPU 2220 also may be a single processor in a multi-core/multiprocessor system, such system operating alone, or in a cluster of computing devices operating in a cluster or server farm. CPU 2220 may be connected to a data communication infrastructure 2210, for example, a bus, message queue, network, or multi-core message-passing scheme.

Device 2200 also may include a main memory 2240, for example, random access memory (RAM), and also may include a secondary memory 2230. Secondary memory 2230, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 2230 may include other similar means for allowing computer programs or other instructions to be loaded into device 2200. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 2200.

Device 2200 also may include a communications interface (“COM”) 2260. Communications interface 2260 allows software and data to be transferred between device 2200 and external devices. Communications interface 2260 may include a modem, a network interface (such as an Ethernet card), a communications port, a PCMCIA slot and card, or the like. Software and data transferred via communications interface 2260 may be in the form of signals, which may be electronic, electromagnetic, optical, or other signals capable of being received by communications interface 2260. These signals may be provided to communications interface 2260 via a communications path of device 2200, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 2200 also may include input and output ports 2250 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A method of managing information monitoring for contextually-relevant data, comprising:
determining a plurality of subscription configuration settings of one or more data of a plurality of data sources with respect to a plurality of users, each subscription configuration setting being based on an interaction with an application interface by a respective user among the plurality of users;
determining a plurality of groups of users among the plurality of users, each group of users being determined based on one or more attributes of each user of the group or respective subscription configuration settings of each user of the group;
determining, for a targeted user among the plurality of users an affiliated group among the plurality of groups of users; and
determining a recommended subscription configuration setting for the targeted user of one or more data of the plurality of data source based on the affiliated group.

2. The method of claim 1, wherein the affiliated group is determined based on one or more attributes of the targeted user and the one or more attributes of each user of the group, and respective subscription configuration settings of each user of the group.

3. The method of claim 1, wherein the recommended subscription configuration setting is based on one or more of one or more attributes of the targeted user, the one or more attributes of each user of the affiliated group, or respective subscription configuration settings of each user of the group.

4. The method of claim 3, wherein the one or more attributes of the targeted user and the one or more attributes of each user of the affiliated group each comprise one or more of a library application used by the user, a role of the user within an organization, or a placement of the user within an organizational structure or the organization.

5. The method of claim 3, wherein the recommended subscription configuration setting is further based on a threshold number or a threshold percentage of users of the affiliated group having a subscription configuration setting matching one or more of: watched data of a plurality of data sources, a dossier comprising the watched data, and filter settings of the dossier.

6. The method of claim 3, wherein the recommended subscription configuration setting is further based on a certification level of a dossier comprising watched data of a plurality of data sources.

7. The method of claim 3, further comprising:
monitoring a membership list of at least one or the targeted user, the affiliate group, or each user of the group;
determining a change in the membership list; and
updating the plurality of subscription configurations settings according the determined change in the membership list.

8. A system for managing information monitoring for contextually-relevant data, comprising:
one or more processor; and
one or more machine-readable media store software including instructions that, when executed by the one or more processors, cause the system to perform operations comprising:
determining a plurality of subscription configuration settings of one or more data of a plurality of data sources with respect to a plurality of users, each subscription configuration setting being based on an interaction with an application interface by a respective user among the plurality of users;
determining a plurality of groups of users among the plurality of users, each group of users being determined based on one or more attributes of each user of the group or respective subscription configuration settings of each user of the group;
determining, for a targeted user among the plurality of users an affiliated group among the plurality of groups of users; and
determining a recommended subscription configuration setting for the targeted user of one or more data of the plurality of data source based on the affiliated group.

9. The system of claim 8, wherein the affiliated group is determined based on one or more attributes of the targeted user and the one or more attributes of each user of the group, and respective subscription configuration settings of each user of the group.

10. The system of claim 8, wherein the recommended subscription configuration setting is based on one or more of one or more attributes of the targeted user, the one or more attributes of each user of the affiliated group, or respective subscription configuration settings of each user of the group.

11. The system of claim 10, wherein the one or more attributes of the targeted user and the one or more attributes of each user of the affiliated group each comprise one or more of a library application used by the user, a role of the user within an organization, or a placement of the user within an organizational structure or the organization.

12. The system of claim 10, wherein the recommended subscription configuration setting is further based on a threshold number or a threshold percentage of users of the affiliated group having a subscription configuration setting matching one or more of: watched data of a plurality of data sources, a dossier comprising the watched data, and filter settings of the dossier.

13. The system of claim 10, wherein the recommended subscription configuration setting is further based on a certification level of a dossier comprising watched data of a plurality of data sources.

14. The system of claim 10, further comprising:
monitoring a membership list of at least one or the targeted user, the affiliate group, or each user of the group;
determining a change in the membership list; and
updating the plurality of subscription configurations settings according the determined change in the membership list.

15. One or more non-transitory computer-readable media storing instructions that, when executed by one or more processors, cause a performance of operations for managing information monitoring for contextually-relevant data, the operations comprising:
determining a plurality of subscription configuration settings of one or more data of a plurality of data sources with respect to a plurality of users, each subscription configuration setting being based on an interaction with an application interface by a respective user among the plurality of users;
determining a plurality of groups of users among the plurality of users, each group of users being determined based on one or more attributes of each user of the group or respective subscription configuration settings of each user of the group;
determining, for a targeted user among the plurality of users an affiliated group among the plurality of groups of users; and
determining a recommended subscription configuration setting for the targeted user of one or more data of the plurality of data source based on the affiliated group.

16. The one or more non-transitory computer-readable media of claim 15, wherein the affiliated group is determined based on one or more attributes of the targeted user and the one or more attributes of each user of the group, and respective subscription configuration settings of each user of the group.

17. The one or more non-transitory computer-readable media of claim 15, wherein the recommended subscription configuration setting is based on one or more of one or more attributes of the targeted user, the one or more attributes of each user of the affiliated group, or respective subscription configuration settings of each user of the group.

18. The one or more non-transitory computer-readable media of claim 17, wherein the one or more attributes of the targeted user and the one or more attributes of each user of the affiliated group each comprise one or more of a library application used by the user, a role of the user within an organization, or a placement of the user within an organizational structure or the organization.

19. The one or more non-transitory computer-readable media of claim 17, wherein the recommended subscription configuration setting is further based on a threshold number or a threshold percentage of users of the affiliated group having a subscription configuration setting matching one or more of: watched data of a plurality of data sources, a dossier comprising the watched data, and filter settings of the dossier.

20. The one or more non-transitory computer-readable media of claim 17, wherein the recommended subscription configuration setting is further based on a certification level of a dossier comprising watched data of a plurality of data sources.
